(19) United States
(12) Patent Application Publication
(10) Pub. No.: US 2019/0329454 A1
(43) Pub. Date: Oct. 31, 2019

(54) HYBRID APPARATUS FOR DRYING AND IMPREGNATING POLYMERIC PELLETS FOR MANUFACTURING OF FOAMED POLYMER ARTICLES

(71) Applicant: LINDE AKTIENGESELLSCHAFT, Munich (DE)

(72) Inventors: Rolf HENINGER, Hoehenkirchen-Siegertsbrunn (DE); Andreas KUERTEN, Iserlohn (DE); Fabian MASCHOTTA, Hagen Westf (DE); Andreas PRALLER, Germering Oberbay (DE); Pawel SZYCH, Munich (DE)

(73) Assignee: Linde Aktiengesellschaft, Munich (DE)

(21) Appl. No.: 16/312,356

(22) PCT Filed: Jun. 22, 2017
(86) PCT No.: PCT/EP2017/065475

§ 371 Date: Dec. 21, 2018

(30) Foreign Application Priority Data
Jun. 23, 2016 (EP) 16001414.8

(51) Int. Cl. B29B 9/16; B29B 13/06; B29C 44/34

(52) U.S. Cl. CPC B29B 9/16; B29B 2009/161; B29C 44/3461; B29B 13/065

(57) ABSTRACT

The present invention relates to a device for drying and impregnating a material with a fluid blowing agent, having a blowing agent source (13) for providing a fluid blowing agent (20), a first vessel (11) set up to dry a material (22) with the fluid blowing agent (20) or a drying gas (25) and to load the dried material (23) with the fluid blowing agent (20) at a pressure of at least 2 bar, wherein the first vessel (11) can be flow-connected to the blowing agent source (13) or to the blowing agent source (13) and a drying gas source (17) for provision of the drying gas (25), and a dryer (14) for removing water (27) from the fluid blowing agent (21) or the drying gas (26), wherein the dryer (14) can be flow-connected to the first vessel (11).

### TECHNICAL AREA

The invention relates to an apparatus for drying and impregnating a material with a fluid blowing agent.

### RELATED ART, PARTICULARLY DISADVANTAGES AND TECHNICAL PROBLEMS THEREOF

Under certain conditions, it is possible for plastics, in particular polymeric pellets to take up and store carbon dioxide. These conditions include parameters such as pressure and duration of exposure to carbon dioxide, and the type of plastic, for example.

Materials of such kind which are exposed to or impregnated with a blowing agent such as carbon dioxide may advantageously be used to produce articles with a cell structure, in an injection moulding or extrusion process, for example.

In order to prepare a material which is impregnated with a blowing agent for use in the manufacture of an article or component with cell structure by injection moulding or extrusion, it is typically necessary to dry the material before it is impregnated. This is particularly necessary if the material to be impregnated is a hygroscopic polymer.

A variety of different apparatuses are suggested for this purpose in the related art, such as dry air dryers, drum dryers, low pressure or vacuum dryers, compressed air dryers or hot air dryers. However, these have to be integrated in the existing plant at the cost of relatively substantial labour and expense.

It would therefore be desirable to make simple, financially reasonable devices available which are not only able to dry the material but can also be loaded with a blowing agent.

### SUMMARY OF THE PRESENT INVENTION: OBJECT, SOLUTION, ADVANTAGES

Against the background of the disadvantages and inadequacies described above, and with due appreciation for the related art as outlined in the preceding text, the object underlying the present invention is to provide an apparatus for the simple, financially reasonable preparation of materials impregnated with a blowing agent which enables the manufacture of components with cellular structure.

This object is solved according to the invention with an apparatus having the features of claim 1 and an apparatus having the features of claim 2. Advantageous variants and practical further developments of the present invention are described in the claims subordinate to each of the independent claims and will be described in the following text.

According to the present invention, a hybrid apparatus is provided in which in particular polymeric pellets may be both dried and impregnated, particularly with a blowing agent, for the purpose of manufacturing foamed polymer articles, for example.

For this purpose, according to claim 1 an apparatus is provided for drying and impregnating a material with a fluid blowing agent.

In this context, the apparatus according to the invention includes:
a blowing agent source for providing a fluid blowing agent,
a first vessel, which is designed to dry a material with the fluid blowing agent or a drying gas and to load and impregnate the dried material with the fluid blowing agent at a pressure of at least 2 bar, wherein the first vessel can be brought into flow-connection with the blowing agent source or with the blowing agent source and a drying gas source for provision of a drying gas, and
a dryer for removing water from the fluid blowing agent or the drying gas, wherein the dryer may be brought into flow-connection with the first vessel.

In such an apparatus, the material may advantageously first be dried in the first vessel and then loaded and impregnated with the fluid blowing agent afterwards.

For this purpose it is particularly provided that the first vessel is first filled with the material, then the fluid blowing agent or the drying gas is passed through the first vessel as drying agent, and then the fluid blowing agent in is fed into the first vessel to load or impregnate the material, which is now dried, with the fluid blowing agent.

According to one embodiment of the apparatus according to the invention, it is provided that the first vessel is designed for loading the dried material with the fluid blowing agent at a pressure in the range from 2 bar to 100 bar, preferably at a pressure in the range from 20 bar to 50 bar.

According to one embodiment of the apparatus according to the invention, the first has a first inlet and a first inlet valve for blocking and/or opening the first inlet. The first inlet is configured to introduce the material (for example in pellet form) into the first vessel.

According to one embodiment of the apparatus according to the invention, the first vessel also has a second inlet and a second inlet valve for blocking and/or opening the second inlet.

In this case, the second inlet is configured to introduce the fluid blowing agent or the drying gas into the first vessel and may therefore be brought into flow-connection with the blowing agent source or the drying gas source, so that in particular a predefined pressure may be set in the first vessel.

The first vessel also has a first outlet and a first outlet valve for blocking and/or opening the first outlet. The first outlet is configured to discharge the material (for example in pellet form) from the first vessel, wherein the first outlet may include a metered dispensing unit (for example in the form of a rotary gate valve) as well as the first outlet valve.

According to one embodiment of the apparatus, the first vessel according to the invention further has a second outlet and a second outlet valve for blocking and/or opening the second outlet, wherein the second outlet is configured to discharge blowing agent from the first vessel, to lower the pressure in the first vessel, for example.

According to one embodiment of the apparatus according to the invention, the first vessel has a third inlet and a third inlet valve for blocking and/or opening the third inlet. The third inlet is configured to introduce the drying gas into the first vessel when the second inlet is provided for introducing the blowing agent into the first vessel.

The third inlet may also be configured to introduce the blowing agent into the first vessel when the second inlet is provided to introduce the drying gas into the first vessel.

According to an alternative to the object of claim 1, an apparatus for drying and impregnating a material with a fluid blowing agent having the features of claim 2 is provided.

Accordingly, the alternative submission according to the invention has:
a blowing agent source for providing a fluid Blowing agent,
a first vessel, which is designed to dry a material with the fluid blowing agent or a drying gas, wherein the first vessel can be brought into flow connection with the blowing agent source or a drying agent source,
a second vessel, which is designed to load or impregnate the dried material with the fluid blowing agent at a pressure of at least 2 bar, wherein the second vessel can be brought into flow connection with the blowing agent source, and
a dryer for removing water from the fluid blowing agent or the drying gas, wherein the dryer may be brought into flow connection with the first vessel.

Within the meaning of the present invention, a dryer is understood to be any apparatus in which water can be removed from a gas or fluid.

Within the scope of the present invention, a fluid blowing agent is understood to mean a gas-phase and/or fluid blowing with the exception of water. The blowing agent is preferably for example carbon dioxide (CO₂) or an inert gas such as nitrogen (N₂) or a noble gas, for example helium or argon. The blowing agent may contain additional substances.

In particular, the fluid blowing agent is anhydrous, that is to say in particular that the water content thereof does not exceed one percent by volume, 0.5 percent by volume or 0.1 percent by volume of the saturation concentration of water in the respective blowing agent when the blowing agent is also intended for drying the material.

In particular, the apparatus according to a preferred embodiment of the apparatus according to the invention is embodied according to claim 1 or 2 to dry the material that is to be dried with the fluid blowing agent, wherein the fluid blowing agent may preferably be passed into or through the first vessel in such manner that the fluid blowing agent is able to wash around the material located therein and water on or in the material may be taken up by the fluid blowing agent in the process.

In order to regenerate the fluid blowing agent, the apparatus according to the invention is in particular further designed to be able to forward the fluid blowing agent charged with water into the dryer, and to transport the dried fluid blowing agent back into the first vessel.

According to an alternative embodiment of the apparatus according to the invention having the features of claim 1 or 2, the apparatus is designed to dry the material to be dried with a drying gas, such as compressed air or an inert gas which is different from the fluid blowing agent, such as nitrogen or argon, for example, wherein the drying gas may preferably be passed into or through the first vessel in such manner that the drying gas is able to wash around the material located therein and water on or in the material may be taken up by the drying gas in the process.

In order to regenerate the drying gas, the apparatus according to the invention is in particular further designed to be able to forward the drying gas charged with water into the dryer, and to transport the dried drying gas agent back into the first vessel.

According to a further embodiment of the apparatus according to the invention, in particular according to claim 2, it is provided that the first vessel has a first inlet and a first inlet valve for blocking and/or opening the first inlet. The first inlet is configured to introduce material (for example in pellet form) into the first vessel.

According to a further embodiment of the apparatus according to the invention, in particular according to claim 2, it is provided that the first vessel has a second inlet and a second inlet valve for blocking and/or opening the first inlet.

The second inlet is configured to introduce the blowing agent or the drying gas into the first vessel, and may therefore be brought into flow connection with the blowing agent source or the drying gas source, so that a predefined pressure may be set in particular in the first vessel.

According to a further embodiment of the apparatus according to the invention, particularly as described in claim 2, it is provided that the second vessel has a first inlet and a first inlet valve for blocking and/or opening the first inlet.

In this case, the first inlet is configured to introduce the fluid blowing agent into the second vessel and may therefore be brought into flow connection with the blowing agent source, so that a predefined pressure may be set in particular in the second vessel.

According to a further embodiment of the apparatus according to the invention, particularly as described in claim 2, it is provided that the second vessel has a first outlet and a first outlet valve for blocking and/or opening the first outlet.

In this case, the first outlet is configured to discharge the impregnated material. The first outlet preferably also has a metered dispensing unit, such as a rotary gate valve, for example.

According to a further embodiment of the apparatus according to the invention, particularly as described in claim 2, it is provided that the second vessel has a second outlet and a second outlet valve for blocking and/or opening the second outlet, wherein the second outlet is configured to discharge blowing agent from the second vessel, to lower the pressure in the second vessel, for example.

According to one embodiment of the present invention, it is provided that the temperature in the first vessel may be controlled, in particular in a range from 0° C. to 200° C., preferably in a range from 20° C. to 140° C.

According to a further embodiment of the present invention, it is provided that the temperature in the second vessel may be controlled, in particular in a range from 0° C. to 200° C., preferably in a range from 20° C. to 140° C.

According to one embodiment of the apparatus according to the invention, particularly as described in claim 2, it is provided that the first vessel is connected to the second vessel in such manner that the dried material can be forwarded from the first vessel into the second vessel, preferably via a pipe which in particular has a valve for blocking or opening the pipe and/or a metered dispensing unit such as a rotary gate valve, for example.

According to one embodiment of the apparatus according to the invention, particularly as described in claim 2, it is provided that the first vessel is designed for loading the dried material with the fluid blowing agent at a pressure of at least 2 bar, particular at a pressure in the range from 2 bar to 100 bar, preferably at a pressure in the range from 20 bar to 50 bar.

According to one embodiment of the apparatus according to the invention, particularly as described in claim 2, it is provided that the first vessel may be brought into flow connection with the blowing agent source and the drying gas source, wherein in particular the first vessel has a third inlet with a third inlet valve for blocking and/or opening the third inlet.

In this context, the third inlet is configured to introduce blowing agent or drying gas into the first vessel and may therefore be brought into flow connection with the blowing agent source or the drying gas source, so that a predefined pressure may be set in particular in the first vessel.

The first vessel in particular also has a first outlet and a first outlet valve for blocking or opening the first outlet. The first outlet is configured to discharge blowing agent from the first vessel, in order to lower the pressure in the first vessel, for example.

The first vessel in particular also has a second outlet and a second outlet valve for blocking and/or opening the second outlet. The second outlet is configured to discharge material (for example in pellet form) from the first vessel, wherein the second outlet may have a metered dispensing unit (in the form of a rotary gate valve, for example) as well as the second outlet valve.

According to one embodiment of the apparatus according to the invention, particularly as described in claim 2, it is provided that the second vessel is designed for drying the material with the fluid blowing agent or the drying gas, wherein the second vessel may optionally be brought into flow connection with the drying gas source.

With the embodiment of the apparatus according to the invention described above, particularly as described in claim 2, it is advantageously possible to dry the material and to load or impregnate it with the blowing agent in parallel in both the first and the second vessel.

Moreover, in this embodiment a connection between the first vessel and the second vessel for transporting the dried material from the first to the second vessel is advantageously not necessary.

In particular, the second vessel has a second inlet and a second inlet valve for blocking and/or opening the second inlet. The second inlet is configured to introduce material (in pellet form, for example) into the second vessel.

According to one embodiment of the apparatus according to the invention, particularly as described in claim 2, it is provided that the second vessel may be brought into flow connection with the dryer in order to remove water from the fluid blowing agent or from the drying gas.

According to a further embodiment of the apparatus according to the invention, particularly as described in claim 2, it is provided that the second vessel has a third inlet and a third inlet valve for blocking and/or opening the third inlet.

In this case, the third inlet is configured to introduce drying gas into the second vessel and may therefore be brought into flow connection with the drying gas source, so that a predefined pressure may be set in particular in the second vessel.

According to one embodiment of the apparatus according to the invention according to claim 1 or 2, it is provided that the dryer may be brought into flow connection with the blowing agent source or the drying gas source in order to remove water from the fluid blowing agent or from the drying gas.

In this way, the fluid blowing agent or the drying gas may advantageously be recycled into the respective source, so that the consumption of blowing agent and/or drying gas may be reduced significantly.

According to one embodiment of the apparatus according to the invention as described in claim 1 or 2, it is provided that the first vessel may be brought into flow connection with the second vessel, preferably via a pipe, which in particular has a valve for blocking or opening the pipe. In such case, the pipe is in particular configured to transport the fluid blowing agent from the first vessel to the second vessel or vice versa.

Thus it is advantageously possible for fluid blowing agent that has been used previously to impregnate the material in one of the two vessels to be used to impregnate the material in the other vessel. In this way too, it is possible for the consumption of fluid blowing agent to be reduced.

According to one embodiment of the apparatus according to the invention as described in claim 1 or 2, it is provided that the blowing agent source is a carbon dioxide source.

According to one embodiment of the apparatus according to the invention as described in claim 1 or 2, it is provided that the drying gas source is a compressed air source.

According to one embodiment of the apparatus according to the invention as described in claim 1 or 2, it is provided that the dryer for removing water from the fluid blowing agent or from the drying gas is embodied as a compressed gas dryer or a compressed air dryer which may be operated with the drying gas, in particular air, or with the fluid blowing agent, in particular carbon dioxide, wherein the drying gas or the fluid blowing agent is compressed and/or cooled in the dryer in such manner that the water in the drying gas or in the fluid blowing agent may be precipitated and removed as condensation water.

### BRIEF DESCRIPTION OF THE DRAWING

As was discussed above, there are various options for configuring and designing the teaching of the present invention to beneficial effect. For this purpose, on the one hand reference is made to the claims subordinate to claim 1 and those subordinate to claim 2, and on the other further configurations, features and advantages of the present invention are explained in greater detail in the following text, including with reference to the exemplary embodiments illustrated in FIG. 1 to FIG. 6.

In the drawing:

FIG. 1 is a schematic representation of an embodiment of an apparatus according to the invention;

FIG. 2 is a schematic representation of an alternative embodiment of the apparatus according to the invention;

FIG. 3 is a schematic representation of a further alternative embodiment of the apparatus according to the invention;

FIG. 4 is a schematic representation of a further alternative embodiment of the apparatus according to the invention;

FIG. 5 is a schematic representation of a further alternative embodiment of the apparatus according to the invention; and

FIG. 6 is a schematic representation of a further alternative embodiment of the apparatus according to the invention.

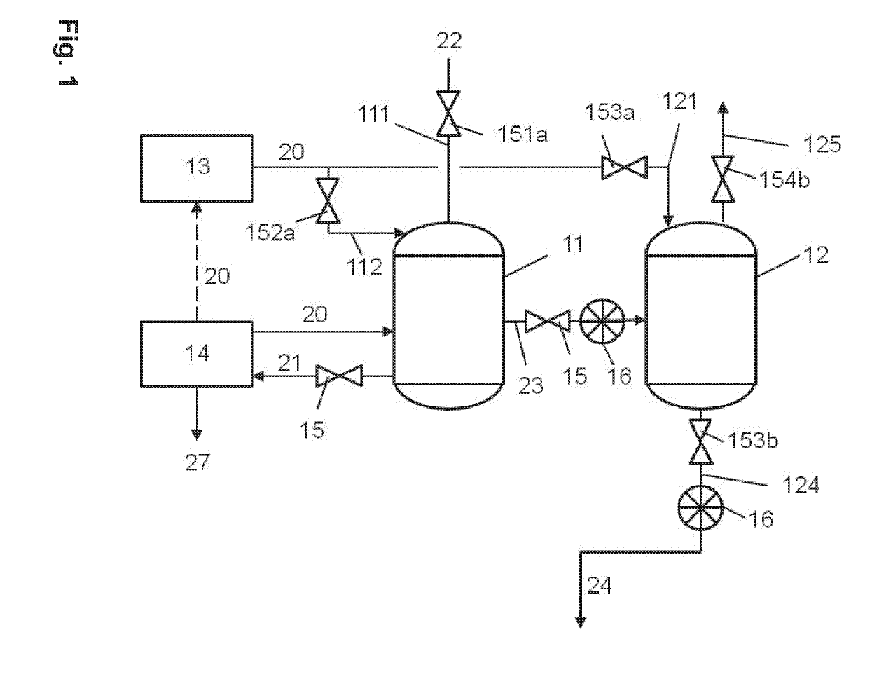

Identical, similar or equivalent variants, elements or features are identified in FIG. 1 to FIG. 6 with the same reference sign; the description these variants, elements or features is not repeated.

### PREFERRED EMBODIMENT OF THE PRESENT INVENTION; BEST WAY TO IMPLEMENT THE PRESENT INVENTION

In order to avoid unnecessary repetition, unless otherwise indicated the following explanations of the variants, features and advantages of the present invention apply to all embodiments of the present invention that are illustrated in FIG. 1 to FIG. 6.

According to the invention, the provision of a hybrid apparatus in particular is intended, in which in particular polymer pellet material may be both dried and impregnated, in particular with a blowing agent, for the purpose of manufacturing foamed polymer articles, for example.

FIG. 1 illustrates a preferred embodiment of the apparatus according to the invention. Accordingly, the apparatus includes a first vessel 11, which is designed for drying the polymeric pellets 22 that are to be impregnated.

The first vessel 11 has at least one first inlet 111 for loading the vessels with the polymeric pellets 22 to be dried, which vessel is preferably equipped with a first inlet valve 151a for blocking or opening the first inlet 111.

In order to dry the polymeric pellets 22, the first vessel is connected to a carbon dioxide source 13 in such manner that carbon dioxide 20 may be passed from the carbon dioxide source 13 into the first vessel 11, preferably via a second inlet 112, which is preferably equipped with a second inlet valve 152a for blocking or opening the second inlet 112.

The carbon dioxide 20 washes over the polymeric pellets 22 in the first vessel 11 and in so doing take up substantially all of the water 27 bound on or in the polymeric pellets 22. After the polymeric pellets 22 in the first vessel 11 have been rinsed, it is necessary to remove the water 27 that is now in the carbon dioxide 21 from said carbon dioxide 21.

Therefore, the first vessel 11 is connected to a gas drying plant or gas dryer 14 in such manner that the moistened carbon dioxide 21 may be passed into the gas dryer 14, preferably via a pipe, which may be equipped with a valve 15 for blocking or opening the pipe.

In the gas dryer 14, water 27 that has been extracted from the polymeric pellets 22 may be removed from the carbon dioxide 20, and the carbon dioxide 20 which is now dry again may be fed back into the first vessel 11, preferably via a corresponding pipe again, to remove any moisture still remaining from the polymeric pellets for example.

Alternatively or in addition, the gas dryer 14 may be connected to the carbon dioxide source 13 in such manner that the dried carbon dioxide 20 may be fed back into the carbon dioxide source 13. The drying of the moist carbon dioxide 21 may advantageously have the effect of significantly reducing the consumption of carbon dioxide by the apparatus according to the invention.

In addition, the first vessel 11 may have an outlet 115, preferably equipped with an outlet valve 152b, via which carbon dioxide 20, 21 may be discharged from the apparatus.

In order to impregnate the now dried polymeric pellets 23, it is further provided that the apparatus according to the invention has a second vessel 12 which is designed for impregnating the dried polymeric pellets 23, in particular at a pressure in the range from 2 bar to 100 bar, preferably at a pressure in the range from 20 bar to 50 bar.

In this case, the second vessel 12 is connected to the carbon dioxide source 13 in such manner that the carbon dioxide 20 can be introduced into the second vessel 12, preferably via a first inlet 121, which is equipped with a first inlet valve 153a for blocking or opening the first inlet 121.

In order to fill the second vessel 12 with dried polymeric pellets 23, this second vessel 12 is connected to the first vessel 11 in such manner that the dried polymeric pellets 23 can be transferred from the first vessel 11 into the second vessel, preferably via a pipe, which may also be equipped with a metered dispensing unit such as a rotary gate valve 16 in addition to a valve 15 for blocking and opening the pipe.

To enable the dried and impregnated polymeric pellets 24 to be discharged, the second vessel 12 has at least one first outlet 124 and a first outlet valve 153b which serves to block or open the first outlet 124. The first outlet 124 may further be equipped with a metered dispensing unit, in the form of a rotary gate valve 16, for example.

Additionally, the second vessel 12 may also be equipped with a second outlet 125, through which carbon dioxide 20 may be discharged or passed out of the second vessel 12. The second outlet 125 preferably has a second outlet valve 154b. In particular, the second outlet 125 may also be used to control the pressure of the carbon dioxide in the second vessel 12.

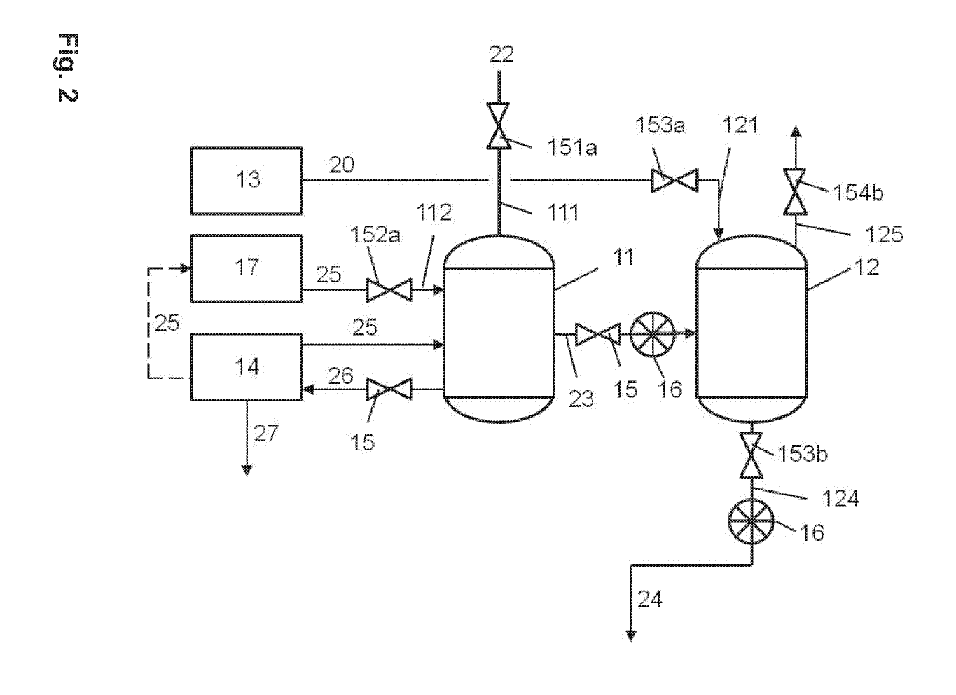

As shown in FIG. 2, the first vessel 11 may alternatively be connected to a compressed air source 17 instead of to the blowing agent source 13 in such manner that the dry compressed air 25 may be fed into the first vessel 11, wherein the compressed air 25 is intended to dry the polymeric pellets 22.

Similarly to when carbon dioxide 20 is used as the drying agent, the moistened compressed air 26 may also be directed to the gas dryer 14 after flowing through the first vessel 11, water 27 may be removed from the compressed air 25 in the gas dryer, and compressed air 25, which is now dry again, may be returned to the first vessel 11.

For this purpose, the vessel 11 is connected to the compressed air source 17 in such manner that the compressed air 25 may be fed into the first vessel 11 via the second inlet 112. At the same time, the gas dryer 14 may also be connected to the compression source 17 in such manner that the dried compressed air 25 may be fed back into the compressed air source 17.

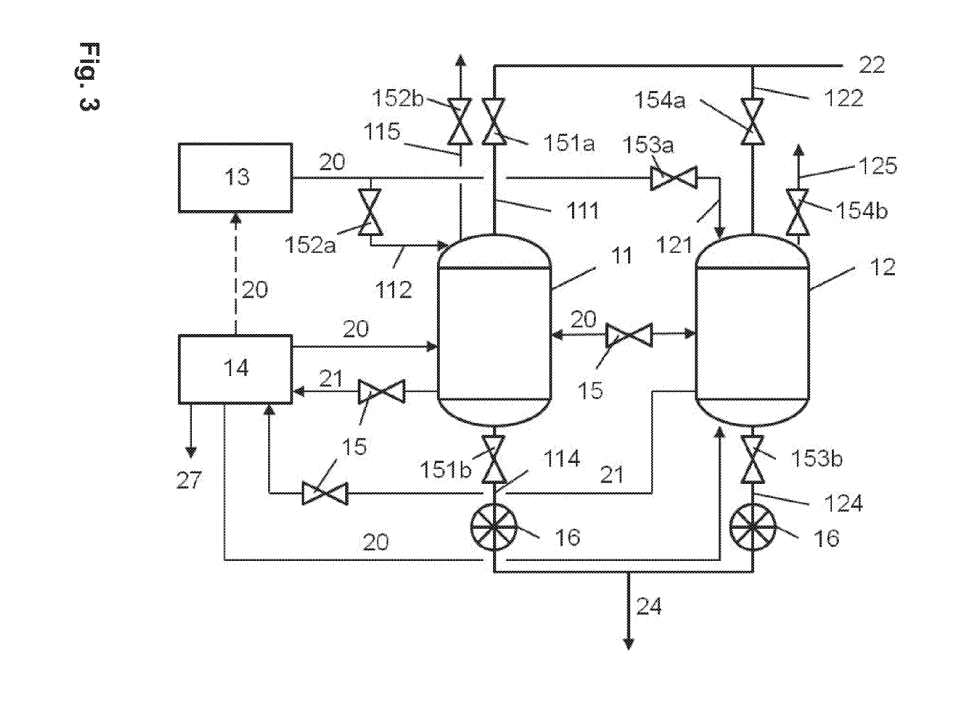

FIG. 3 shows a further alternative embodiment of the apparatus according to the invention. In this case, it is provided that both the first vessel 11 and the second vessel 12 are designed for drying the polymeric pellets 22 and for impregnating the dried polymeric pellets 23 at a pressure in the range from 2 bar to 100 bar, preferably at a pressure in the range from 20 bar to 50 bar.

For this purpose, the first vessel 11 and the second vessel each have an inlet 111, 122 for introducing the polymeric pellets 22 into the respective vessel 11, 12 with a valve 151a, 154a for blocking or opening the first inlet 111, 122, and an outlet 114, 124 for discharging the polymeric pellets 24 which have been dried and impregnated with carbon dioxide 20, wherein each outlet 114, 124 may also be equipped with an outlet valve 151b, 153b and a metered dispensing unit such as a rotary gate valve 16.

In this context, both the first vessel 11 and the second vessel 12 are additionally connected to a carbon dioxide source 13 so that carbon dioxide 20 may be fed into the first vessel 11 and the second vessel 12 as a drying agent, preferably via the respective inlets 112, 121, each of which being equipped with an inlet valve 152a, 153a to block or open the inlet 112, 121.

In addition, the first vessel 11 and the second vessel each have a further outlet 115, 125 which is designed to allow the discharge of carbon dioxide 20 from the respective vessel 11, 12, and so enable the pressure in the vessels 11, 12 to be controlled. Each of these outlets 115, 125 is preferably also equipped with an outlet valve 152b, 154b.

The first vessel 11 and the second vessel 12 are also connected to a gas dryer 14 in the same way as the first vessel 11 in the embodiments shown in FIG. 1 or FIG. 2, in other words moistened carbon dioxide 21 may be fed from the first vessel 11 or from the second vessel 12 into the gas dryer 14, and the carbon dioxide 20 dried therein may be fed back into the first vessel 11 or the second vessel 12.

At the same time it is provided that the first vessel 11 and the second vessel 12 are connected to each other in such a manner that carbon dioxide 20 may be passed from first vessel 11 to the second Vessel 12 or vice versa.

In this way, carbon dioxide 20 which was used for impregnating the dried polymeric pellets 23 in the first vessel 11 may advantageously be forwarded to the second vessel 12 so that it may be used for impregnation there as well. By this means, the carbon dioxide consumption of the apparatus according to the invention may be reduced significantly.

Advantageously, with this embodiment it is further possible to dry and impregnate polymeric pellets 22 in parallel in both vessels. For example, it would be conceivable for the polymeric pellets 22 to be dried in the first vessel 11, while previously dried polymeric pellets 23 are impregnated in the second vessel 12.

After completion of drying in the first vessel 11 and impregnation in the second vessel 12, the carbon dioxide 20 may be transported out of the second vessel 12 into the first vessel 11 and used for impregnating there, while fresh carbon dioxide 20 from the carbon dioxide source 13 or “recycled” carbon dioxide 20 from the gas drying device 14 is fed into the second vessel 12 to be used for drying.

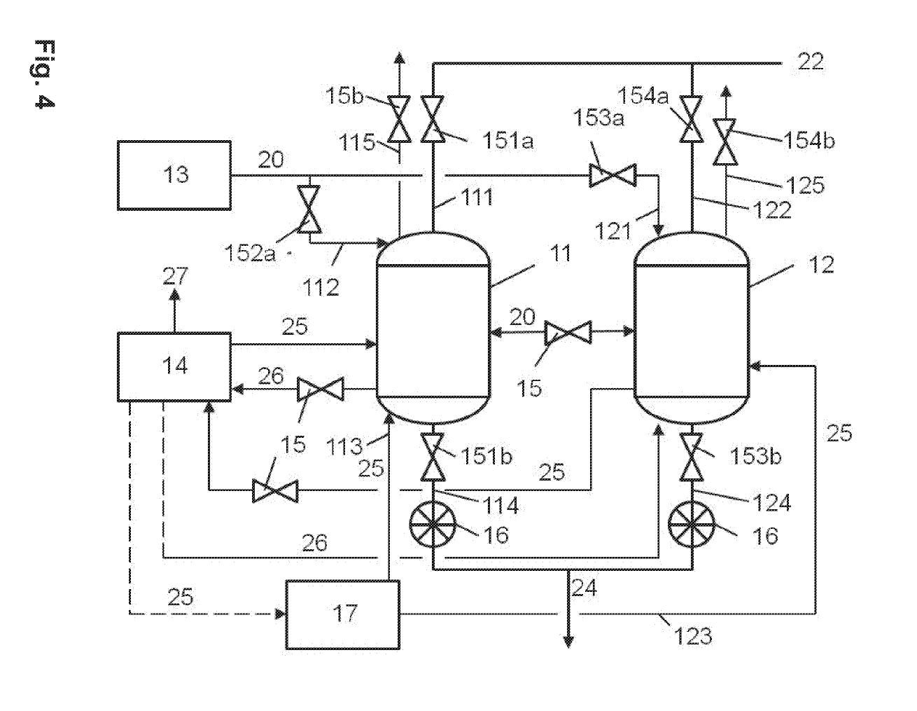

Here too, as shown in FIG. 4 it is possible for the first vessel 11 and the second vessel 12 to be connected additionally to a compressed air source 17 in such manner that compressed air 25 may be fed into to the first vessel 11 and the second vessel 12. For this purpose, the first vessel 11 and the second vessel 12 each have a third inlet 113, 123 with a third inlet valve, via which compressed air may be introduced into the first vessel 11 and the second vessel.

The first vessel 11 and the second vessel 12 are also connected to a gas dryer 14 in such manner that the compressed air 26 which is moistened when drying the polymeric pellets 22 may be fed back into the gas dryer 14, and the compressed air 25 that has been dried in the gas dryer 14 may be returned to the first vessel 11 and the second vessel 12.

Here too, the gas dryer 14 may be connected to the compressed air source 17 in such manner that the compressed air 25 which is dried in the dryer 14 may also be returned to the compressed air source 17.

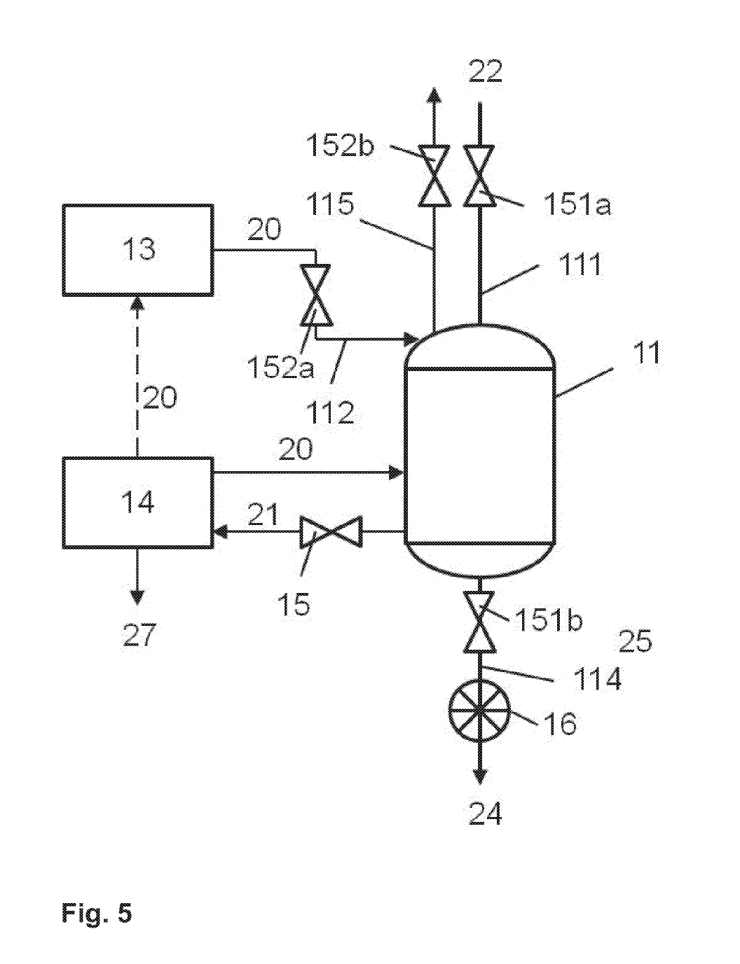

A further alternative embodiment of the apparatus according to the invention is represented in FIG. 5. In this embodiment, the apparatus has only a first vessel 11, which is designed both to dry the polymeric pellets 22 and to impregnate the dried polymeric pellets 23 at a pressure in the range from 2 bar to 100 bar, preferably at a pressure from 20 bar to 50 bar.

The first vessel 11 is connected to a carbon dioxide source 13 in such manner that carbon dioxide may be fed into the first vessel 11, in particular via an inlet 112 having an inlet valve 152a for blocking or opening the inlet 112.

The first vessel also has a further inlet 111 with a further inlet valve 151a for blocking or opening the further inlet 111, through which the first Vessel 11 may be filled with polymeric pellets 22, and a first outlet 114, preferably with a first outlet valve 151b and a metered dispensing device such as a rotary gate valve 16, wherein the first outlet 114 is designed to discharge the impregnated material 24.

The first vessel 11 is also connected to a gas dryer 14 in such manner that moistened carbon dioxide 21 may be passed from the first vessel 11 into the gas dryer 14, and dried carbon dioxide 20 may be passed back into the first vessel 11.

Here too, the gas dryer 14 may be connected to the carbon dioxide source 13 in such manner that the dried carbon dioxide 20 may be fed back to the carbon dioxide source 13.

Additionally, the first vessel has a second outlet 115, through which the carbon dioxide 20 may be transported away or discharged from the first vessel 11. The second outlet 115 preferably has a second outlet valve 152b. In particular, the second outlet 115 may be used to control the carbon dioxide pressure in the first vessel 11.

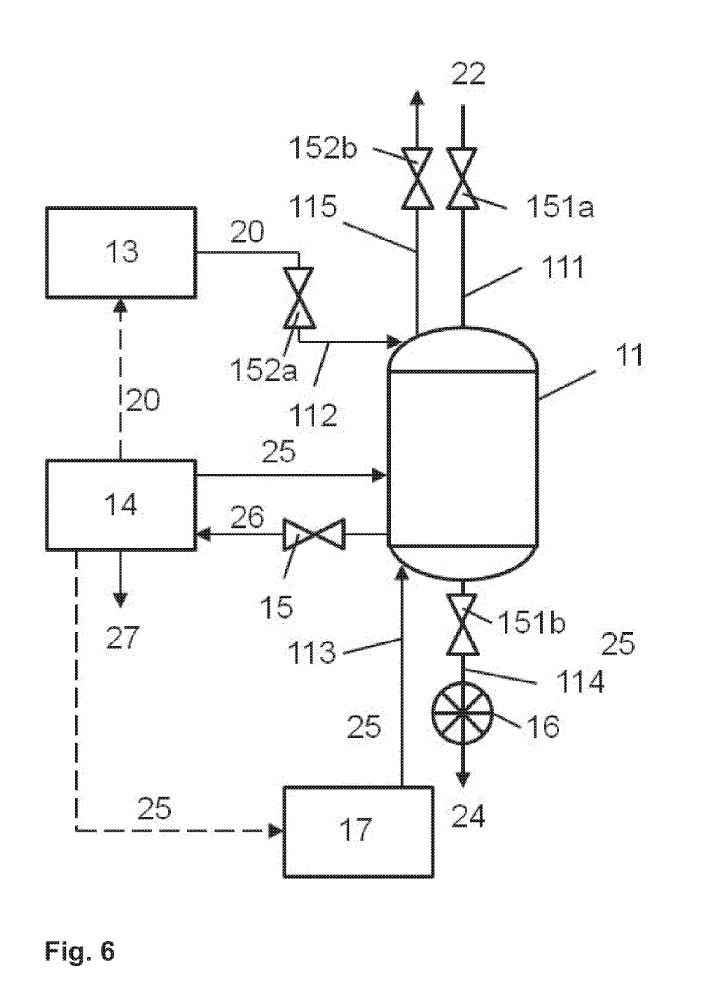

But, as shown in FIG. 6 the first vessel 11 may also be connected to a compressed air source 17 in such manner that compressed air 25 can be introduced to dry the polymeric pellets 22 in the first vessel 11, in particular via a third inlet 113, which may preferably be equipped with a third inlet valve.

In this case, the first vessel 11 is connected to a gas dryer 14 in such manner that the compressed air 26 which is moistened by drying the polymeric pellets 22 may be fed into the gas dryer 14 from the first vessel 11, and the compressed air 25 which is dried in the gas dryer 14 may be fed back into the first vessel 11.

Here too, the gas dryer 14 may be connected to the compressed air source 17 in such manner that dried compressed air 25 may also be returned to the compressed air source 17.

### LIST OF REFERENCE SIGNS

11 First vessel
111 First inlet to the first vessel (material)
112 Second inlet to the first vessel (blowing agent or compressed air)
113 Third inlet to the first vessel (blowing agent or compressed air)
114 First outlet from the first vessel (impregnated material)
115 Second outlet from the first vessel (blowing agent)
12 Second vessel
121 First inlet to the second vessel (blowing agent)
122 Second inlet to the second vessel (material)
123 Third inlet to the second vessel (compressed air)
124 First outlet from the second vessel (impregnated material)
125 Second outlet from the second vessel (blowing agent)
13 Carbon dioxide source
14 Dryer, particularly gas dryer
15 Valve
15a Inlet valve
151a First inlet valve to the first vessel (material)
152a Second inlet valve to the first vessels (blowing agent or compressed air)
153a First inlet valve to the second vessel (blowing agent)
154a Second inlet valve to the second vessel (material)
15b Outlet valve
151b First outlet valve from the first vessel (material)
152b Second outlet valve from the first vessels (blowing agent or compressed air)
153b First outlet valve from the second vessel (material)
154b Second outlet valve from the second vessel (blowing agent)
16 Rotary gate valve
17 Compressed air source
20 Carbon dioxide (dry)
21 Carbon dioxide (moistened)
22 Polymeric pellets with residual moisture
23 Polymeric pellets (dry)
24 Polymeric pellets (dry and impregnated with carbon dioxide)
25 Compressed air (dry)
26 Compressed air (moistened)
27 Moisture

1. Apparatus for drying and impregnating a material with a fluid blowing agent, including
a blowing agent source (13) for providing a fluid blowing agent (20),
a first vessel (11), which is designed to dry a material (22) with the fluid blowing agent (20) or a drying gas (25) and to load and impregnate the dried material (23) with the fluid blowing agent (20) at a pressure of at least 2 bar, wherein the first vessel (11) can be brought into flow connection with the blowing agent source (13) or with the blowing agent source (13) and a drying gas source (17) for provision of the drying gas (25), and
a dryer (14) for removing water (27) from the fluid blowing agent (21) or the drying gas (26), wherein the dryer (14) may be brought into flow connection with the first vessel (11).

2. Apparatus for drying and impregnating a material with a fluid blowing agent, including
a blowing agent source (13) for providing a fluid blowing agent,
a first vessel (11), which is designed to dry a material (22) with the fluid blowing agent (20) or a drying gas (25), wherein the first vessel (11) can be brought into flow connection with the blowing agent source (13) or a drying gas source (17) for provision of the drying gas (25),
a second vessel (12), which is designed to load the dried material (23) with the fluid blowing agent (20) at a pressure of at least 2 bar, wherein the second vessel (12) can be brought into flow connection with the blowing agent source (13), and
a dryer (14) for removing water (27) from the fluid blowing agent (21) or the drying gas (26), wherein the dryer (14) can be brought into flow connection with the first vessel (11).

3. Apparatus according to claim 2, wherein the first vessel (11) is connected to the second vessel (12) in such manner that the dried material (23) can be passed from the first vessel (11) into the second vessel (12).

4. Apparatus according to claim 2, wherein the second vessel (12) is designed for drying the material with the fluid blowing agent (20) or with the drying gas (25).

5. Apparatus according to claim 2, wherein the second vessel (12) can be brought into flow connection with the drying gas source (17).

6. Apparatus according to claim 2, wherein the second vessel (12) can be brought into flow connection with the dryer (14) for removing water (27) from the fluid blowing agent (21) or from the drying gas (26).

7. Apparatus according to claim 2, wherein the first vessel (11) can be brought into flow connection with the second vessel (12).

8. Apparatus according to claim 1, wherein the temperature in the first vessel (11) and/or the second vessel (12) can be controlled.

9. Apparatus according to claim 1, wherein the first vessel (11) is designed for loading the dried material (23) with the fluid blowing agent (20) at a pressure of at least 2 bar.

10. Apparatus according to claim 1, wherein the first vessel (11) can be brought into flow connection with the blowing agent source (13) and the drying gas source (17).

11. Apparatus according to claim 1, wherein the dryer (14) can be brought into flow connection with the blowing agent source (13) or the drying gas source (17) for removing water (27) from the fluid blowing agent (21) or from the drying gas (26).

12. Apparatus according to claim 1, wherein the blowing agent source (13) is a carbon dioxide source.

13. Apparatus according to claim 1, wherein the drying gas source (17) is a compressed air source.

14. Apparatus according to claim 1, wherein the dryer (14) is designed as a compressed gas dryer for removing water (27) from the fluid blowing agent (21) or from the drying gas (26).
